(19) United States
(12) Patent Application Publication
(10) Pub. No.: US 2021/0155377 A1
(43) Pub. Date: May 27, 2021

(54) DETACHABLE HANDLE

(71) Applicant: Clifford Struhl, Garden City Park, NY (US)

(72) Inventor: Clifford Struhl, Garden City Park, NY (US)

(21) Appl. No.: 17/075,919

(22) Filed: Oct. 21, 2020

Related U.S. Application Data
(60) Provisional application No. 62/940,467, filed on Nov. 26, 2019.

(51) Int. Cl. B65D 25/28

(52) U.S. Cl. CPC B65D 25/2811; A01K 47/06; B65D 2525/285

(57) ABSTRACT

A detachable handle for lifting, moving and handling of a box is provided. The handle includes a handle grip having a substantially longitudinal body defined along a longitudinal axis. An engagement end is connected to the handle grip and has an engagement means for detachable engagement with a side of the box. Systems and methods are disclosed.

### TECHNICAL FIELD

The present disclosure relates generally to a detachable handle for a box, and more particularly, to a removable handle for a bee hive for lifting and moving such bee hive.

### BACKGROUND OF THE INVENTION

A bee hive ally consists of multiple bee boxes: two different widths (8-frame or 10-frame) and three heights, with 2-3 permanent boxes for the brood (e.g., eggs, larvae and pupae) and 2-3 or more seasonal boxes for honey. Bee boxes, also referred to as supers, have either recess cut into or cleats attached to two opposite sides of the bee box so that the bee boxes can be gripped in order to be lifted or moved for inspection. When the bee boxes are filled with comb, honey, brood and bees, they can weight up to 80 pounds, which is difficult to handle due to the weight, the geometry and shallow depth of the grip area. Moreover, since the grips are flush to the vertical surface of the bee box, the lifting of the bee box requires the use of finger tips. Many beekeepers are women having long finger nails that limit the depth and strength of the grip. In addition, the beekeeper, in many cases, is wearing gloves that prevent a secure grip. Lifting of the bee boxes is further complicated by the fact that the bee boxes in many cases are stuck together by the bee wax and/or propolis (i.e., bee glue), which increases the lifting force needed to separate the bee boxes.

Therefore, there is a need for a device that is easily detachable to the bee boxes and strong enough to handle the heavy weight of the bee boxes to assist in the lifting of the bee boxes. While the detachable handle of the present invention is described in conjunction with bee boxes, these specifics should not be construed as limitations of the invention to be only used for bee boxes. Any box could benefit from the detachable handle claimed herein.

### SUMMARY OF THE INVENTION

A detachable handle for lifting, moving and handling of a box is provided. The handle includes a handle grip having a substantially longitudinal body defined along a longitudinal axis. An engagement end is connected to the handle grip and has an engagement means for detachable engagement with a side of the box. Systems and methods are disclosed.

A handle and box system is provided. The system includes a box having an engagement means. A removable handle for lifting, moving and handling of the box. The handle includes a handle grip having a substantially longitudinal body defined along a longitudinal axis and at least one interior cross bar. An engagement end is connected to the handle grip and having an engagement means for detachably engaging the engagement means of the box.

A handle and box system is provided. The system includes a box having an engagement means. A removable handle for lifting, moving and handling of the box. The handle includes a handle grip having a substantially longitudinal body defined along a longitudinal axis and at least one interior cross bar. An engagement end is connected to the handle grip and having an engagement means for detachably engaging the engagement means of the box. A cover for the box and an elastic strap having two hooks on opposite end of the strap and connectable to the handle grip for securely holding the cover over the box.

### BRIEF DESCRIPTION OF THE DRAWINGS

The present disclosure will become more readily apparent from the specific description accompanied by the following drawings, in which:

FIG. 1 is a perspective view of a handle in accordance with the principles of the present disclosure;

FIG. 2 is a perspective view of a handle in accordance with the principles of the present disclosure;

FIG. 3 is a perspective view of a handle in accordance with the principles of the present disclosure;

FIG. 4 is a perspective view of the components shown in FIG. 3;

FIG. 5 is a perspective view of a handle and box system in accordance with the principles of the present disclosure;

FIG. 6 is a perspective view of the components shown in FIG. 5;

FIG. 7 is a perspective view of the components shown in FIG. 5;

FIG. 8 is a perspective view of a handle in accordance with the principles of the present disclosure;

FIG. 9 is a perspective view of the components shown in FIG. 8;

FIG. 10 is bottom view of the components shown in FIG. 8;

FIG. 11 is a side view of the components shown in FIG. 8;

FIG. 12 is a side view of the components of FIG. 8;

FIG. 13 is a side view of the components of FIG. 8;

FIG. 14 is a side view of the components of FIG. 8;

FIG. 15 is a perspective view of the components of FIG. 8;

FIG. 16 is a perspective view of the components of FIG. 8;

FIG. 17 is a perspective view of the components of FIG. 8;

FIG. 18 is a perspective view of a handle and box system in accordance with the principles of the present disclosure;

FIG. 19 is a perspective view of a handle and box system in accordance with the principles of the present disclosure;

FIG. 20 is a perspective view of a box system in accordance with the principles of the present disclosure;

FIG. 21 is a perspective view of a handle system in accordance with the principles of the present disclosure;

FIG. 22 is a perspective view of a handle and box system in accordance with the principles of the present disclosure;

FIG. 23 is a perspective view of a handle system in accordance with the principles of the present disclosure;

FIG. 24 is a perspective view of a handle system in accordance with the principles of the present disclosure;

FIG. 25 is a perspective view of a handle system in accordance with the principles of the present disclosure;

FIG. 26 is a perspective view of a handle system in accordance with the principles of the present disclosure;

FIG. 27 is a perspective view of a handle system in accordance with the principles of the present disclosure;

FIG. 28 is a perspective view of a handle system in accordance with the principles of the present disclosure; and

FIG. 29 is a perspective view of a handle and box system in operation in accordance with the principles of the present disclosure.

### DETAILED DESCRIPTION

The exemplary embodiments of the handle and box system are disclosed. In some embodiments, the handle includes mounting plates that connect a handle and grip portion via support arms. In some embodiments, the mounting plates have holes with key way to engage a stud on a box. In some embodiments, the mounting plate includes a stud that engages a keyway in the box. In some embodiments, the key way engages a head of screw or stud to attach mounting plate to box. In some embodiments, a handle portion is attached to two sides support arms or connecting elements. In some embodiments, the mounting plates can be connected or separated. In some embodiments, the handle portion is offset from the box to allow full grip. In some embodiments, the handle portion can project above the box to allow a different grip, but preferred to have the top of grip below the top of the box to prevent interference with cover. In some embodiments, flanged bushing studs attach to the box for larger surface engagement to mounting plates. In some embodiments, screw heads can also be used to engage key way. In some embodiments, template pinholes are included in the mounting plate for marking attachment point for studs. In some embodiments, a small upper slot allows handle to be slid down for storage. In some embodiments, the handle is ergonomically shaped. In some embodiments, the grip portion can have a hole for drainage. In some embodiments, the grip portion has interior cross bar of notch/recess for connecting hive strap or hook for holding down cover.

In accordance with aspects of the present disclosure, the slot on the engagement end of the removable handle further comprises a pinhole or notch at the top of the small upper slot for marking positions on the side of the box for installation of the stud.

In accordance with aspects of the present disclosure, the slot on the engagement end of the removable handle has a wedged shape for easily engaging with the stud of the side of the box.

In accordance with aspects of the present disclosure, the stud on the side of the box has a wedged shape to closely engage the engagement end of the removable handle.

The system of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. Also, in some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

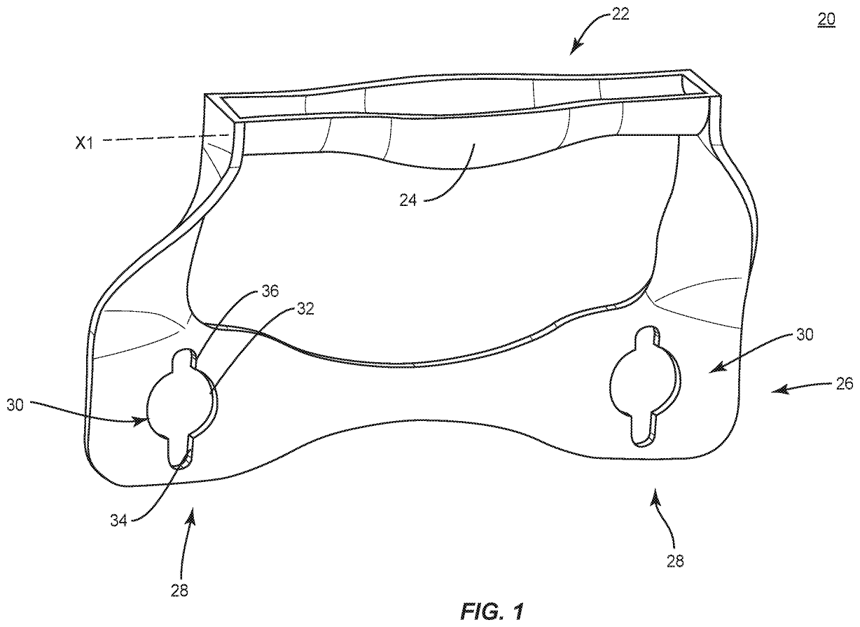

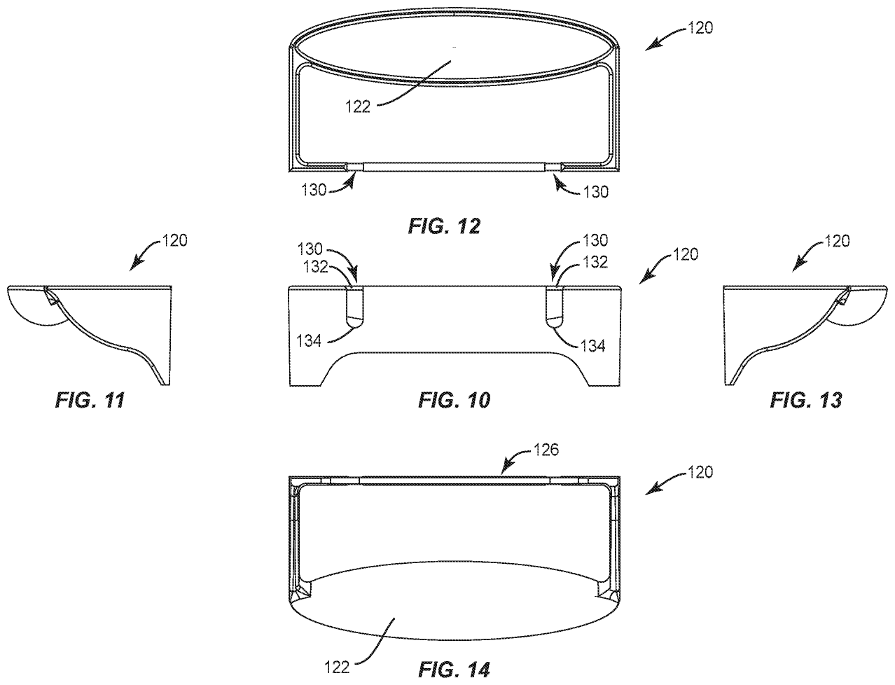

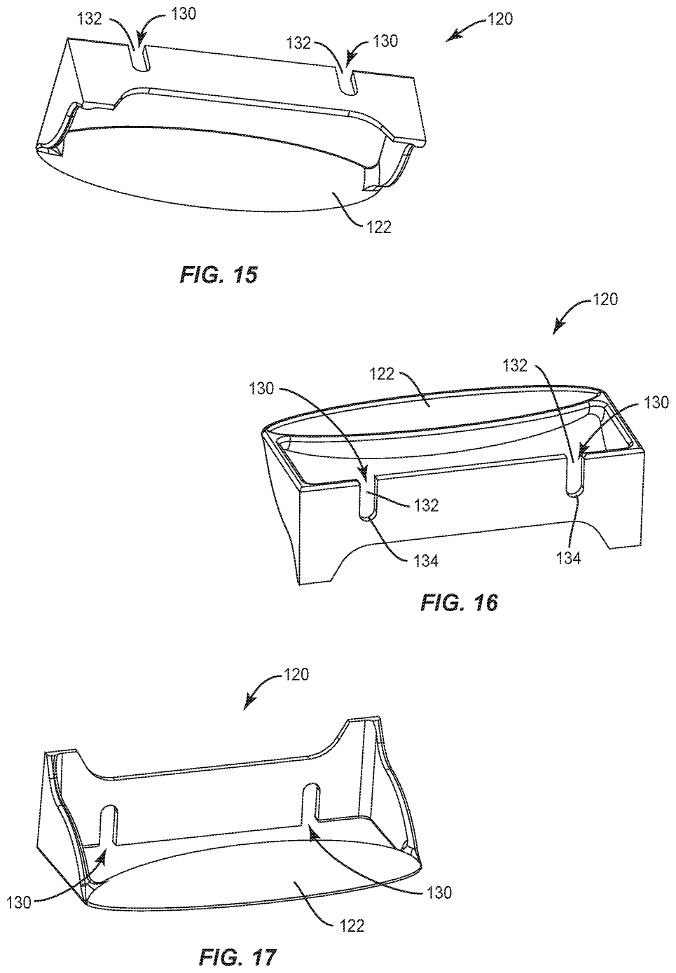

The following discussion includes a description of a box and handle system and related components and methods of employing the system in accordance with the principles of the present disclosure. Alternate embodiments are also disclosed. Reference is made in detail to the exemplary embodiments of the present disclosure, which are illustrated in the accompanying figures. Turning to FIGS. 1-29, there are illustrated components of a box and handle system 10, in accordance with the principles of the present disclosure.

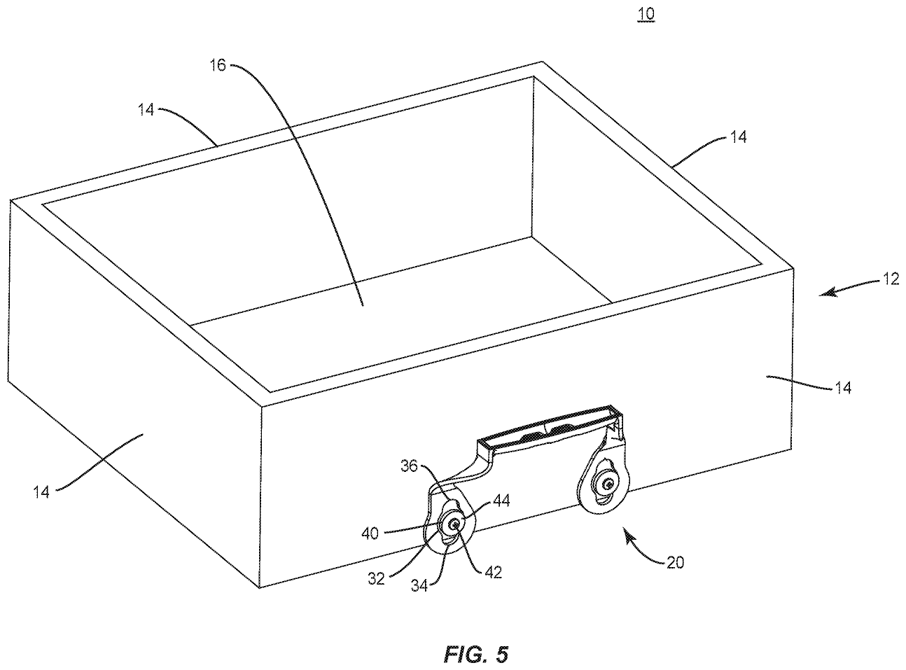

In one embodiment, as shown in FIGS. 1-7, box and handle system 10 includes a box 12 and a detachable handle 20 having an engagement means 28 configured for engagement with box 12, as described herein. Box 12 includes sides 14 and a bottom 16, as shown in FIG. 5. In accordance with aspects of the present disclosure, engagement means 28 may be selected from a group consisting of latch, stud, keyway and slot. In accordance with aspects of the present disclosure, box 12 is equipped with a corresponding engagement means, for example, a latch, stud, keyway or slot for engagement with engagement means 28, as described herein.

Handle 20 is configured for lifting, moving and handling of box 12 in accordance with aspects of the present disclosure. Handle 20 comprises a grip portion 22. Grip 22 includes a substantially longitudinal body 24 defined along a longitudinal axis X1. Handle 20 includes an engagement end 26 extending from or being connected with body 24. End 26 includes one or more engagement means 28 for detachably engaging to a side 14 of box 12. In some embodiments, engagement end 26 is substantially orthogonally connected to handle grip 22. In accordance with other aspects of the present disclosure, engagement end 26 is contortedly connected to handle grip 22.

In one embodiment, as shown in FIGS. 1-7, engagement means 28 includes a slot 30. Slot 30 includes an opening 32 disposed in communication with a notch 34 disposed on one side of opening 32 and a notch 36 disposed on an opposite side of opening 32. In some embodiments, box 12 includes a protrusion, for example, studs 40 extending from one or more of sides 14 configured for disposal with slot 30. Each stud 40 includes an extension 42 and a flange 44 extends circumferentially about extension 42. Flange 44 is configured to resist and/or prevent disengagement of stud 40 from slot 30 during use.

In some embodiments, opening 32 is configured larger than each of notches 34, 36. In some embodiments, opening 32 and/or notches 34, 36 may have various cross section configurations, for example, circular, oval, oblong, triangular, rectangular, square, polygonal, irregular, uniform, non-uniform, variable, tubular and/or tapered.

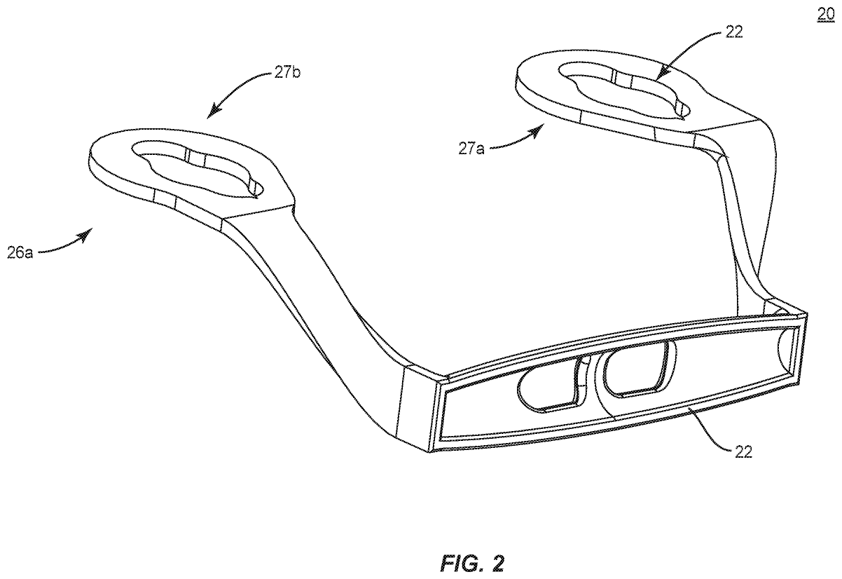

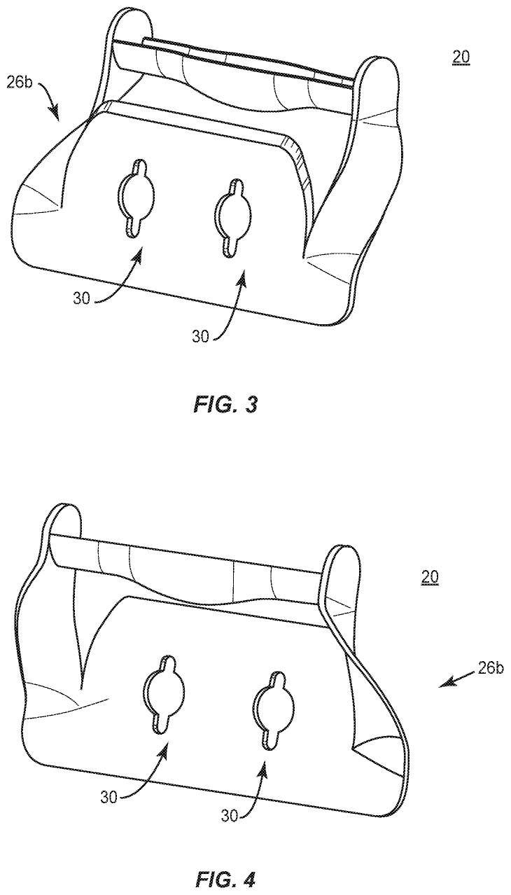

In some embodiments, end 26 includes a narrow continuous portion, as shown in FIG. 1. In some embodiments, end 26a includes individual legs 27a, 27b, as shown in FIG. 2. In some embodiments, end 26b includes a wide continuous portion, as shown in FIGS. 3 and 4.

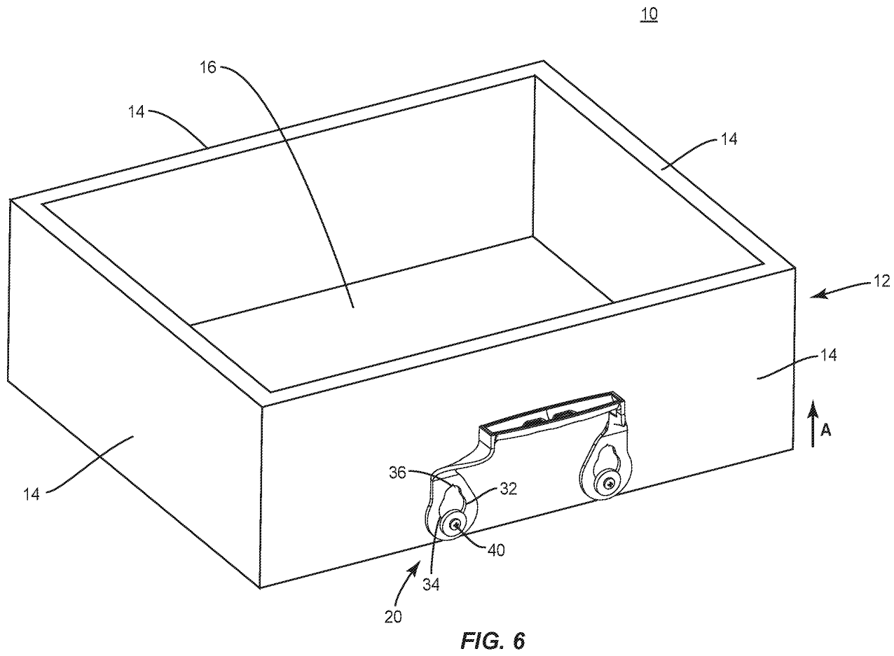

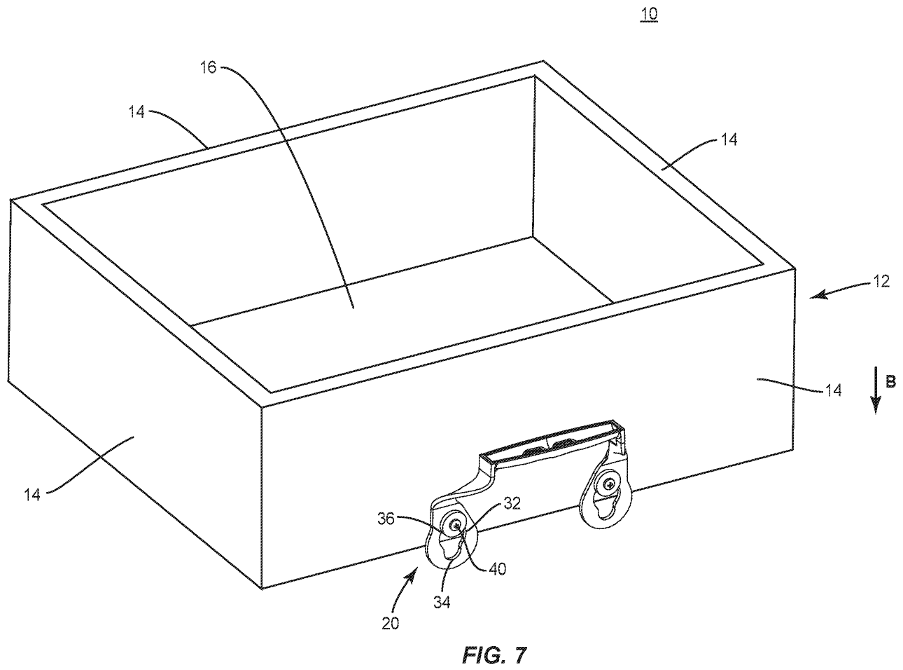

In operation, handle 20 is positioned against a side 14 of box 12. Studs 40 are disposed with openings 32. Handle 20 is movable between an in-use orientation and a storage orientation. For example, when box 12 needs to be lifted or carried, an upwards force, as shown by arrow A in FIG. 6, is applied to handle 20 causing studs 40 to engage the surfaces of notch 34. Flange 44 resists and/or prevents disengagement of stud 40 from notch 34. This allows the user to lift and/or carry box 12. In the storage position, a downward force, as shown by arrow B in FIG. 7, is applied to handle 20 causing studs 40 to engage the surfaces of notch 34. This allows handle to remain securely attached with box 12. Flange 44 resists and/or prevents disengagement of stud 40 from notch 36. To remove handle 20, handle 20 is positioned such that openings 32 are aligned with studs 40 to allow handle 20 to be disengaged from studs 40.

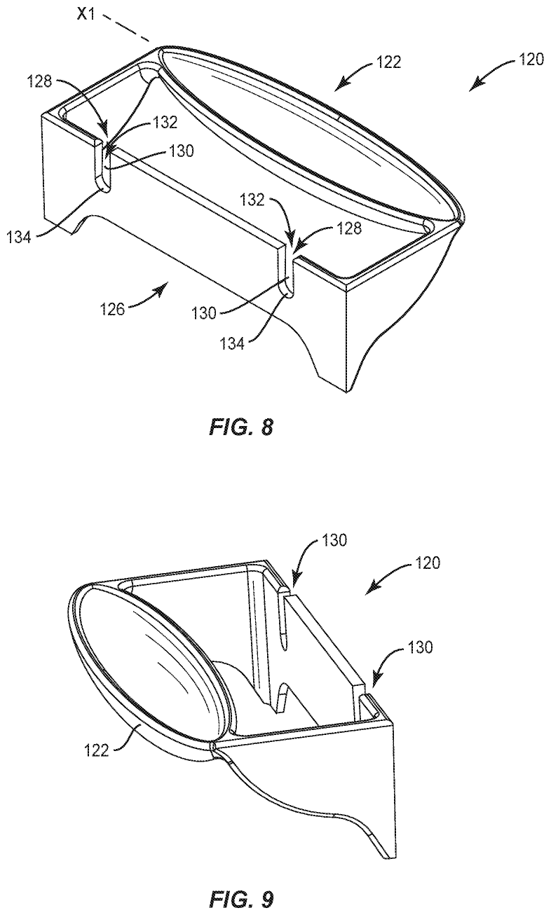

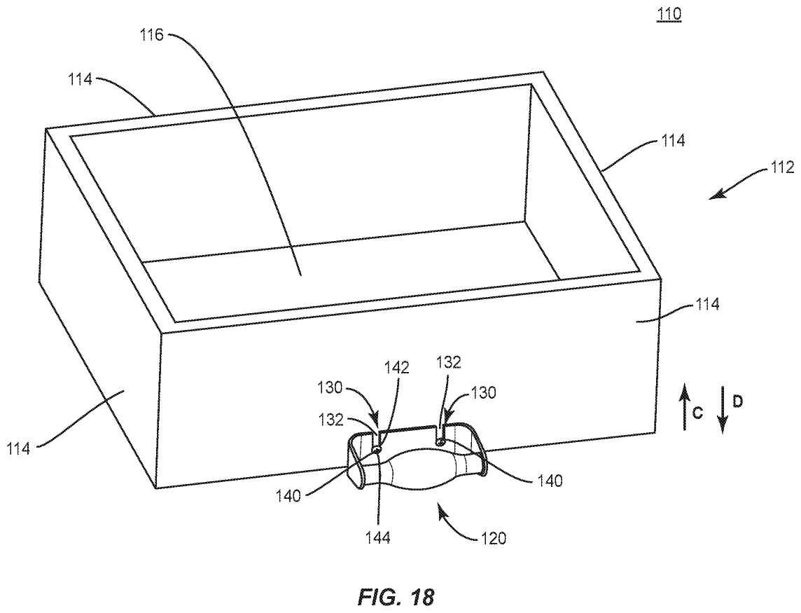

In some embodiments, a box and handle system 110 includes a box 112 and a detachable handle 120 having an engagement means 128 configured for engagement with box 112, as shown in FIGS. 8-18. Box 112 includes sides 114 and a bottom 116, as shown in FIG. 18.

Handle 120 is configured for lifting, moving and handling of box 112 in accordance with aspects of the present disclosure. Handle 120 comprises a grip portion 122. Grip 122 includes a substantially longitudinal body 124 defined along a longitudinal axis X2. Handle 120 includes an engagement end 126 extending from or being connected with body 124. End 126 includes one or more engagement means 128 for detachably engaging to a side 114 of box 112.

Engagement means 128 includes elongated slots 130 having an opening 132 and a surface 134. In some embodiments, box 112 includes a protrusion, for example, studs 140 extending from one or more of sides 114 configured for disposal with slot 130. Each stud 140 includes an extension 142 and a flange 144 extends circumferentially about extension 142. Flange 144 is configured to resist and/or prevent disengagement of stud 140 from slot 130 during use.

In operation, handle 120 is positioned against a side 114 of box 112. Studs 140 are disposed with openings 132. Handle 120 is movable between an in-use orientation and a storage orientation. For example, when box 112 needs to be lifted or carried, handle 120 is positioned such that openings 132 are oriented away from bottom 116. Studs 140 are disposed with openings 132 and handle is translated, in a direction shown by arrow C in FIG. 18, causing studs 140 to translate along slots 130 and engage and/or abut the surface 134. Flange 144 and surface 134 resist and/or prevent disengagement of stud 140 from slot 130. This allows the user to lift and/or carry box 112. In the storage position, handle 120 is positioned such that openings 132 are oriented towards bottom 116. Studs 140 are disposed with openings 132 and handle 120 is translated, in a direction shown by arrow D in FIG. 18, causing studs 140 to translate along slots 130 causing studs 140 to engage surface 134 of slot 130. Flange 144 and surface 143 resist and/or prevent disengagement of stud 140 from slot 130. This allows handle to remain securely attached with box 12. To remove handle 120, handle 120 is translated in a direction causing studs 140 to disengage from slots 130 through openings 132.

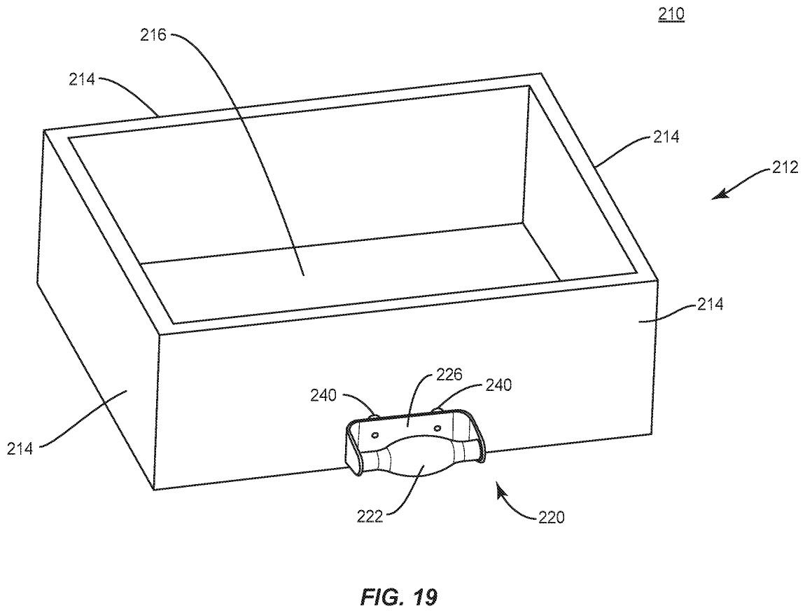

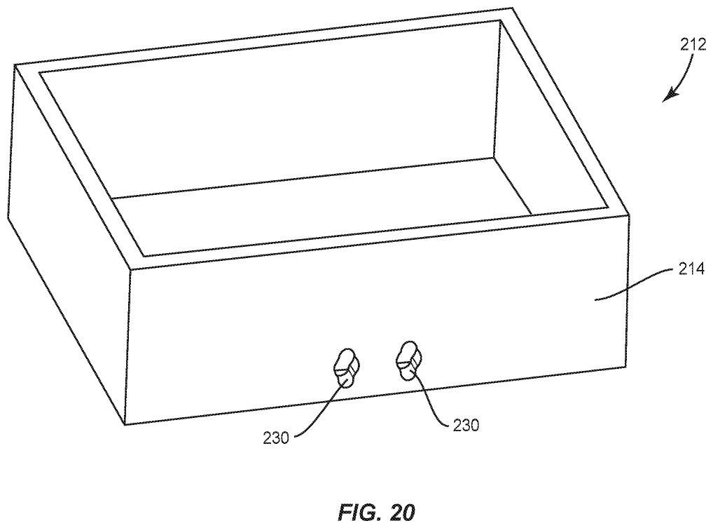

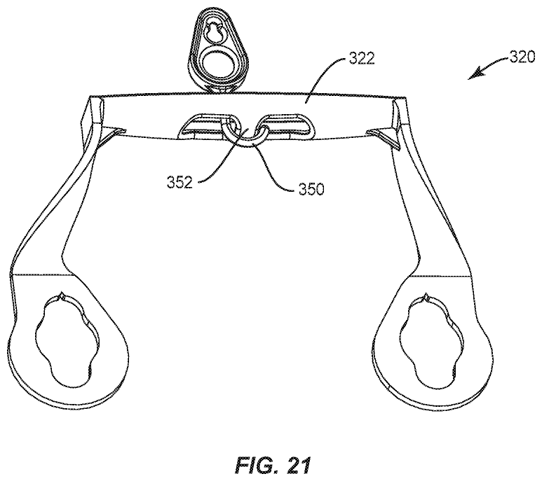

In some embodiments, a box and handle system 210 includes a box 212 and a detachable handle 220 having an engagement means 228 configured for engagement with box 212, as shown in FIGS. 19 and 20. Box 212 includes sides 214 and a bottom 216, as shown in FIG. 19.

Box 212 includes slots 230, similar to slots 30 described herein and shown in FIG. 20. Handle 220, similar to handle 20 described herein, is configured for lifting, moving and handling of box 212 in accordance with aspects of the present disclosure. Handle 220 comprises a grip portion 222. Handle 220 includes an engagement end 226 that includes one or more engagement means 228 for detachably engaging to a side 214 of box 212. Engagement means 228 includes studs 240, similar to studs 40 described herein, and configured for disposal with slots 230 disposed with box 212.

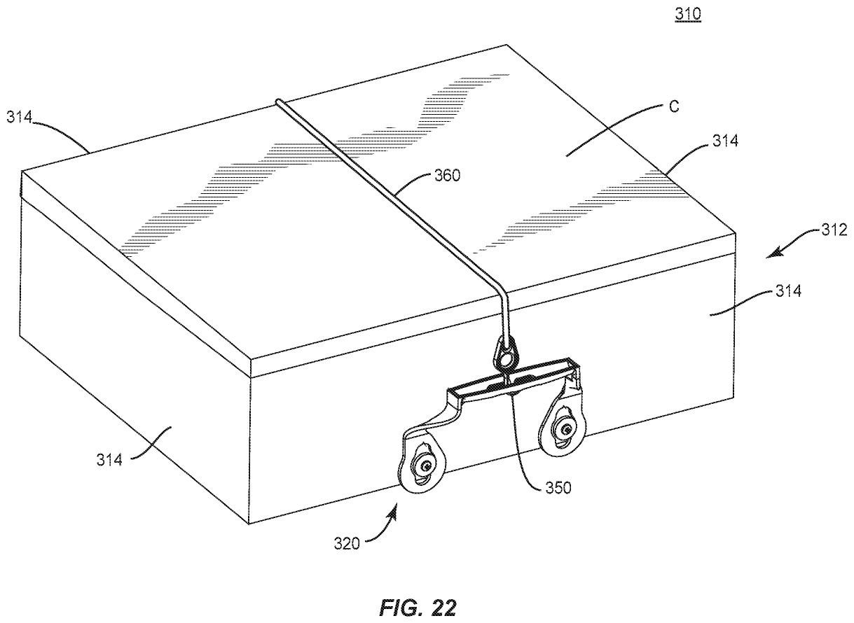

In some embodiments, a box and handle system 310 includes a box 312 and a detachable handle 320 having an engagement means 328 configured for engagement with box 312, as shown in FIGS. 21 and 22. Box 312 includes sides 314, as shown in FIG. 22.

Handle 320 is configured for attachment with box 312 similar to handle 20 and box 12 as described herein and shown in FIGS. 1-8. Handle 320 further includes a hook 350 connected to an interior cross bar 352 of handle grip 322. Hook 350 is connected with an elastic strap 360 wherein a second hook (not shown) is on the opposite end of strap 360 and also connected to the interior cross bar on the other handle grip positioned on the opposite side of box 312. The elastic strap is used for securely attaching a cover C with box 360.

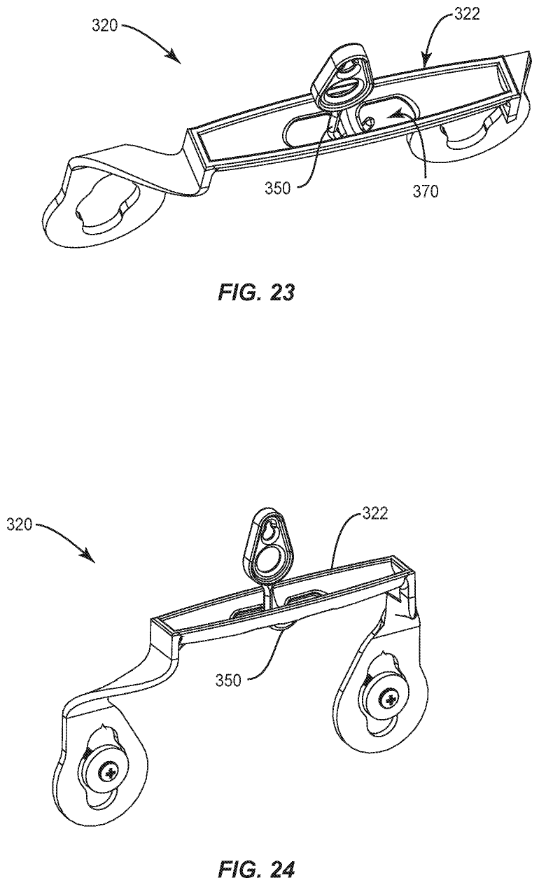

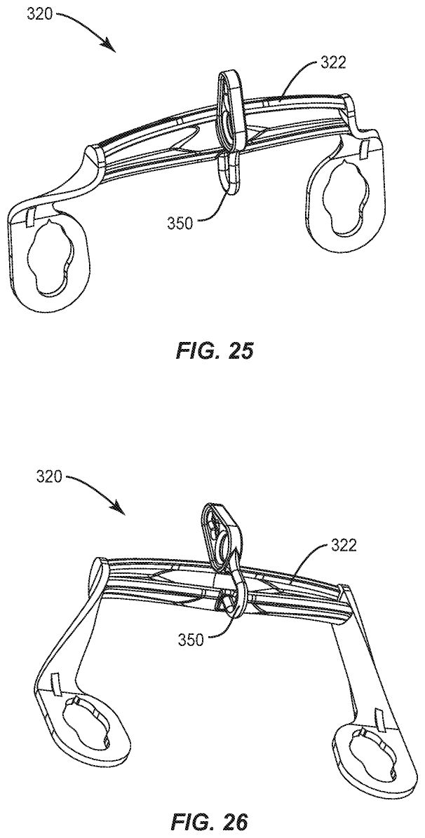

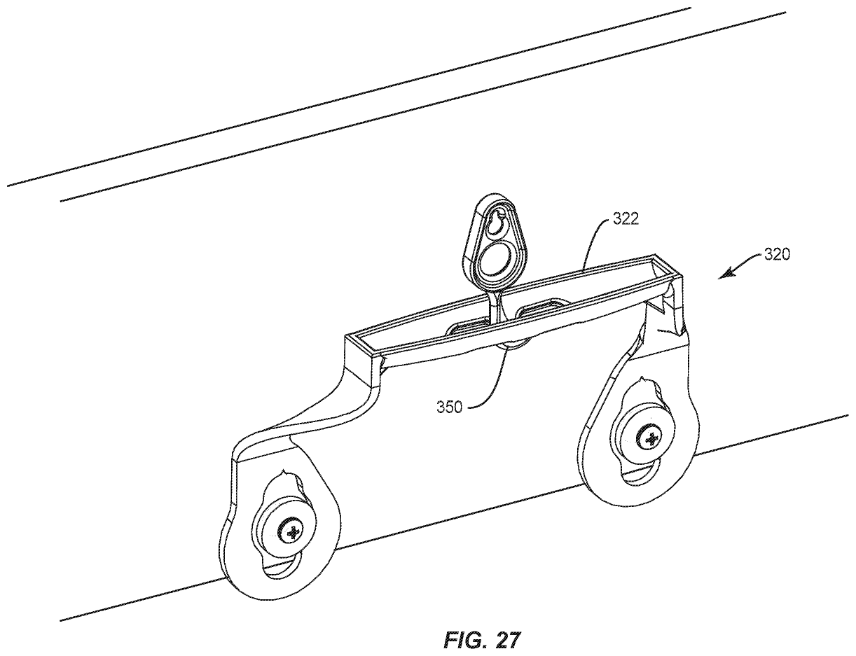

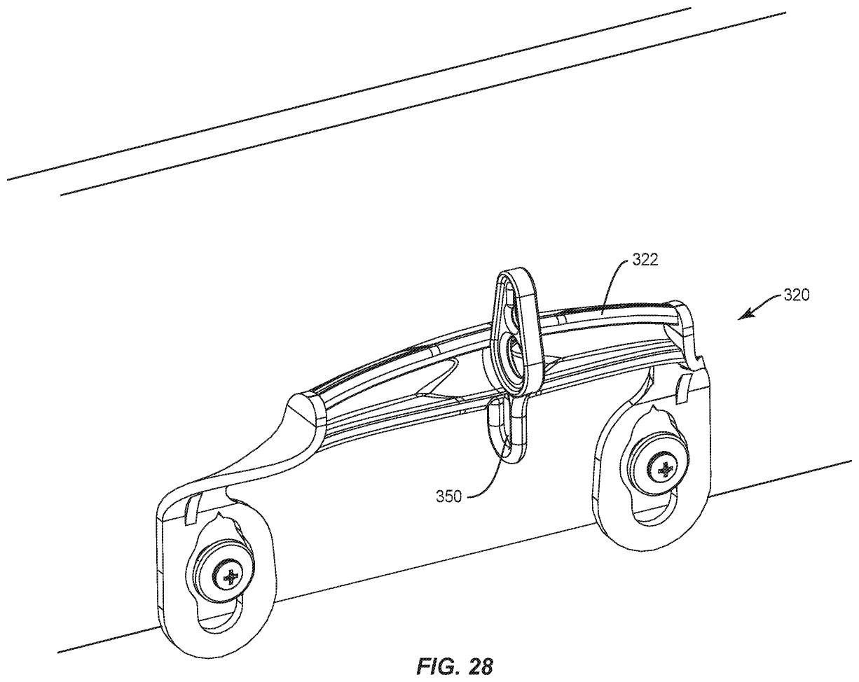

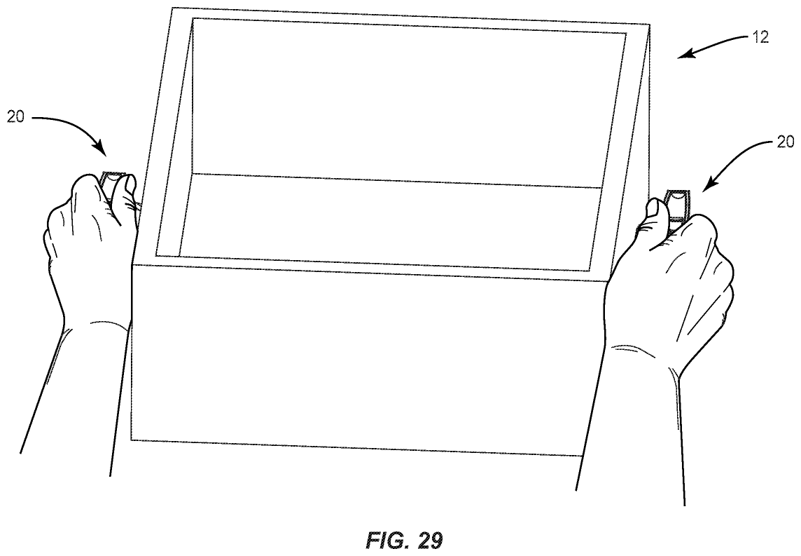

FIG. 23-28 illustrate various methods of connecting hook 350 with handle grip 322. In one embodiment, handle grip 322 may have an opening 370 oriented upwards (FIGS. 23 and 24), downwards, in or outwards (FIG. 25) or at any other angle relative to grip 322. For example, FIGS. 23-26 show the opening on the handle grip faces up, and FIG. 27 shows the opening on grip 322 faces outwards. As shown in FIG. 28, grip 322 may have an interior cross bar or a small indentation to receive hook 350.

In accordance with aspects of the present disclosure, the detachable handle can be fabricated from plastic or metal or any other suitable materials. The detachable handle can be prepared from any suitable processes, such as injection molding, casting, extrusion, etc. The detachable handle can be monolithic, i.e., formed from a single piece of material, or polylithic, i.e., formed from two or more difference materials, or be composed of multiple components.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A detachable handle for lifting, moving and handling of a box, comprising:
a handle grip having a substantially longitudinal body defined along a longitudinal axis, and
an engagement end being connected to the handle grip and having an engagement means for detachable engagement with a side of the box.

2. The detachable handle of claim 1, wherein the engagement means on the engagement end of the removable handle is selected from a group consisting of latch, stud, keyway and slot.

3. The detachable handle of claim 1, wherein the side of the box is equipped with latch, stud, keyway or slot for engaging with the engagement end of the removable handle.

4. The detachable handle of claim 2, wherein the slot on the engagement end of the removable handle comprises a large center hole for receiving a stud connected to the side of the box, a small lower slot for engaging to the stud and a small upper slot for storing the removable handle.

5. The detachable handle of claim 4, wherein the slot on the engagement end of the removable handle further comprises a pinhole at the top of the small upper slot for marking positions on the side of the box for installation of the stud.

6. The detachable handle of claim 4, wherein the slot on the engagement end of the removable handle has a wedged shape for easily engaging with the stud of the side of the box.

7. The detachable handle of claim 6, wherein the stud on the side of the box has a wedged shape to closely engage the engagement end of the removable handle.

8. The detachable handle of claim 1, wherein the detachable handle is fabricated from plastic or metal.

9. The detachable handle of claim 1, wherein the handle grip is ergonomically shaped.

10. A system comprising:
a box having an engagement means;
a removable handle for lifting, moving and handling of the box, comprising:
a handle grip having a substantially longitudinal body defined along a longitudinal axis and at least one interior cross bar, and
an engagement end being connected to the handle grip and having an engagement means for detachably engaging the engagement means of the box.

11. The system of claim 10, wherein the engagement means on the engagement end of the removable handle is selected from a group consisting of latch, stud, keyway and slot.

12. The system of claim 10, wherein the engagement means of the box is equipped with latch, stud, keyway or slot for engaging with the engagement end of the removable handle.

13. The system of claim 11, wherein the slot on the engagement end of the removable handle comprises a large center hole for receiving a stud connected to the side of the box, a small lower slot for engaging to the stud and a small upper slot for storing the removable handle.

14. The system of claim 11, wherein the slot on the engagement end of the removable handle further comprises a pinhole at the top of the small upper slot for marking positions on the side of the box for installation of the stud.

15. The system of claim 11, wherein the slot on the engagement end of the removable handle has a wedged shape for easily engaging with the stud of the side of the box.

16. The system of claim 10, wherein the stud on the side of the box has a wedged shape to closely engage the engagement end of the removable handle.

17. A system comprising:
a box having an engagement means;
a removable handle for lifting, moving and handling of the box, comprising:
a handle grip having a substantially longitudinal body defined along a longitudinal axis and at least one interior cross bar, and
an engagement end being connected to the handle grip and having an engagement means for detachably engaging the engagement means of the box,
a cover for the box, and
an elastic strap having two hooks on opposite end of the strap and connectable to the handle grip for securely holding the cover over the box.

18. The system of claim 17, wherein the handle grip includes an opening configured to receive the hook.

19. The system of claim 17, wherein the detachable handle is fabricated from plastic or metal.

20. The system of claim 12, wherein the handle grip is ergonomically shaped.
